(19) United States
(12) Patent Application Publication
(10) Pub. No.: US 2013/0051896 A1
(43) Pub. Date: Feb. 28, 2013

(54) MARKER

(71) Applicant: Peter M.H. HUNG, Kowloon (HK)

(72) Inventor: Peter M.H. HUNG, Kowloon (HK)

(73) Assignee: FULON DEVELOPMENT LIMITED, Kowloon (HK)

(21) Appl. No.: 13/348,476

(22) Filed: Jan. 11, 2012

(30) Foreign Application Priority Data
Aug. 30, 2011 (CN) 201120320684.5

(51) Int. Cl. B43K 23/08

(52) U.S. Cl. 401/292

(57) ABSTRACT

The utility pertains to stationery, and relates to markers. The marker comprises a shank and a cap fitting over the shank, the front of the shank has a nib, the end of the shank has two grooves in its two sides, and one side of the cap has a fastener. The marker is cuboid according to the utility model, so it is easy to arrange. One or more caps of the markers of the utility model can be connected together to form a cuboid marker, which is stable and comfortable to hold. The markers also can be connected to pack away and carry.

### TECHNICAL FIELD

The utility pertains to stationery, and relates to markers.

### BACKGROUND ART

A marker can mark signs on paper, wood, metal, plastic or porcelain enamel. Normally these signs are colorful. In the prior art, a marker just have a shank, which is inconvenient for users to hold. Most of the markers on sale are columniform. As a result, the marker may roll off the table and break its accessory, such as a nib. At the same time, the prior maker pen doesn't look good, nor can be easily arranged.

### Contents of Utility Model

The utility model relates to a marker which can be hold comfortably and stably.

The technical solution of the utility model is as follows:

A marker, which comprises a shank and a cap fitting over the shank, the front of the shank has a nib, the end of the shank has two grooves in its two sides and one side of the cap has a fastener.

The nib is 18 mm, 8 mm or fine line.

The shape of the fastener is quadrate.

The groove has a hatch at the bottom of the shank, and it's convenient for the shank and the cap to connect with each other.

The shape of the groove is quadrate.

The fastener and the groove match with each other; the fastener and the groove are connected by putting the fastener of the cap into the groove of the shank through the hatch.

The shank and the cap are connected to be a cuboid, so after connecting, the marker is orderly and easy to arrange and carry.

The shank has a protrusion at the bottom of it.

The fastener of the cap can be put into the groove through the hatch, and the marker would be hold easily and stably. Two markers are connected together by putting the fastener of one marker into the groove of another marker. When two markers are connected, it's convenient to hold and order. When combining three markers together, the fastener of one marker is put into the groove of the second one. Then, the fastener of second one is put into the groove of the third marker. More markers also can be connected together in this way to form a cuboid, which is easy to pack away.

The advantageous effects of the utility model as compared with the prior art are as follows:

1. When people writing, one or more caps of the markers of the utility model can be connected together to form a cuboid marker, which is more stable and comfortable.

2. One or more markers of the utility model can be connected. And the connected marker is orderly and easy to arrange and carry.

3. The marker according to the utility model is cuboid, which is beautiful and convenient to pack away.

### DESCRIPTION OF FIGURES

FIG. shows a schematic representation of the shank of the marker according to the utility model.

FIG. 2 shows a schematic representation of the cap of the marker according to the utility model.

FIG. 3 shows a schematic representation of the connection between a shank shown in FIG. 1 and a cap shown in FIG. 2, and the cap is on the top of the shank.

FIG. 4 shows a further connection of the shank shown in FIG. 1 and the cap shown in FIG. 1, and the shank is on the top of the cap.

FIG. 5 shows the front view of the marker shown in FIG. 3.

FIG. 6 shows the side view of the marker shown in FIG. 3.

FIG. 7 shows the top view of the marker shown in FIG. 3.

FIG. 8 shows the bottom view of the marker shown in FIG. 3.

FIG. 9 shows a schematic representation of the cap and the shank that are connected together of the marker according to the utility model.

FIG. 10 shows a schematic representation of the connection procedure of two markers according to the utility model.

FIG. 11 shows a schematic representation of two connected markers.

FIG. 12 shows a schematic representation of the connection procedure of three markers according to the utility model.

FIG. 13 shows a schematic representation of three markers that are connected together.

### SPECIFIC MODE FOR CARRYING OUT THE INVENTION

The marker according to the utility model is explained in more detail by the figure:

A marker, which comprises a shank 1 and a cap 2 that fitting over the shank, FIG. 1 shows a schematic representation of the shank of the marker according to the utility model. The front of the shank 1 has a nib 11, the end of the shank 1 has two grooves 12 in its two sides and shank 1 has a protrusion 13 at the end of it.

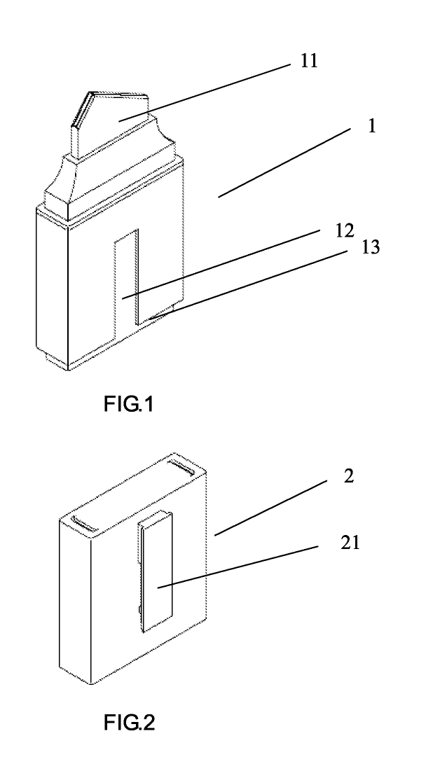

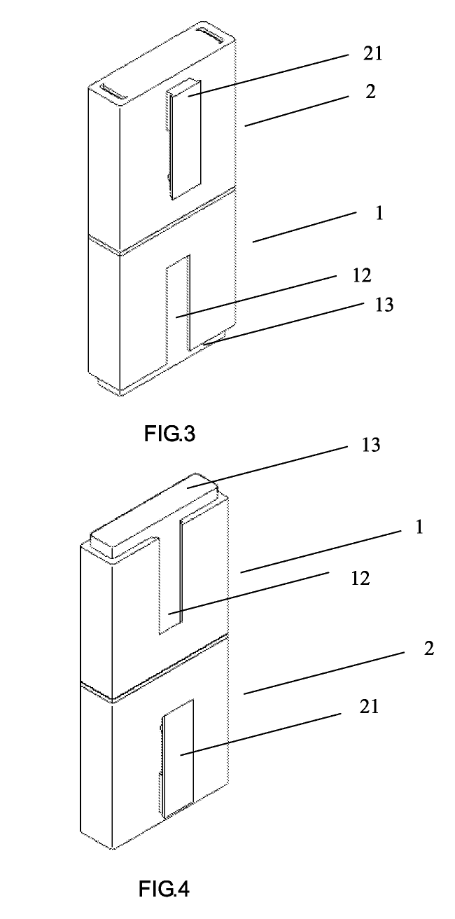

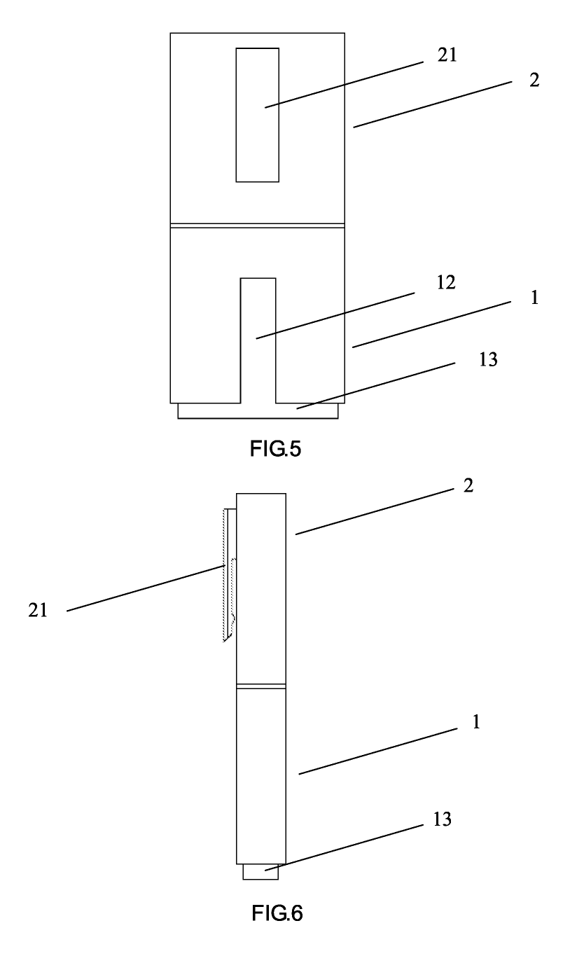

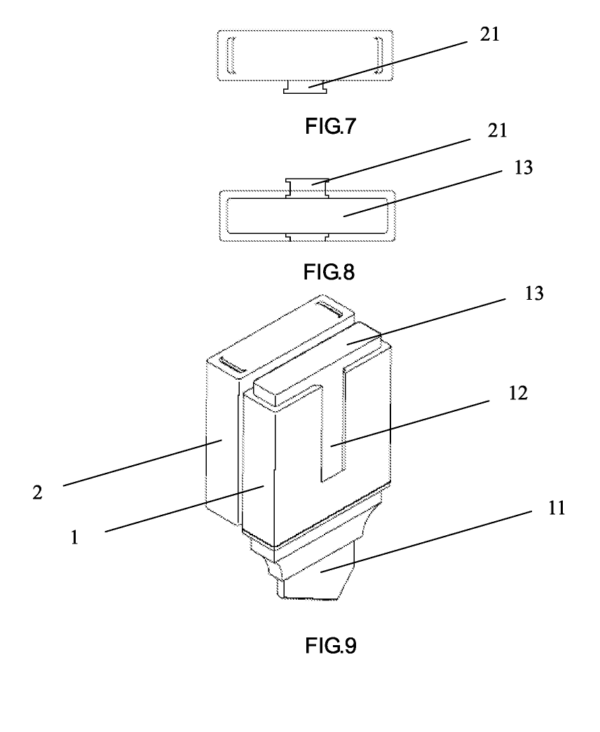

FIG. 2 shows a schematic representation of the cap of the marker according to the utility model. There is a fastener 21 located on the side of the cap 2. FIG. 3 shows a schematic representation of the connection between a shank shown in FIG. 1 and a cap shown in FIG. 2, and the cap is on the top of the shank. FIG. 4 shows another connection style of the shank shown in FIG. 1 and the cap shown in FIG. 2, and the shank is on the top of the cap. FIG. 5 shows the front view of the marker shown in FIG. 3. FIG. 6 shows the side view of the marker shown in FIG. 3. FIG. 7 shows the top view of the marker shown in FIG. 3. FIG. 8 shows the bottom view of the marker shown in FIG. 3.

The nib of the marker is 18 mm, 8 mm or fine line. The users can choose the size all by themselves. The shape of the fastener 21 is quadrate. The groove 12 has a hatch at the bottom of the shank 1. It's convenient for the shank and the cap to connect with each other. The fastener 21 and the groove 12 match with each other. The fastener 21 is put into the groove 12 through the hatch, so the fastener and the groove are connected. The shank 1 and the cap 2 are connected to be a cuboid, which is easy to carry and place.

The marker is thin, so it's not convenient to hold. The fastener is put into the groove through the hatch, and the connected markers would be more stable.

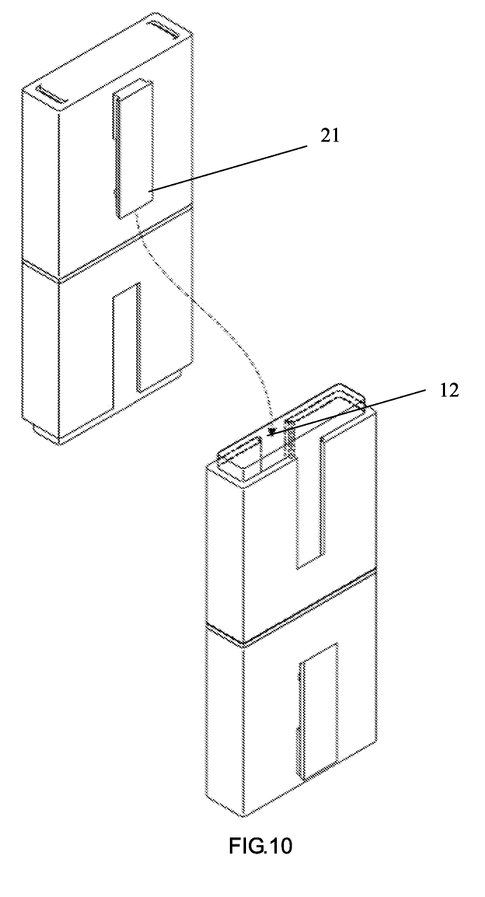

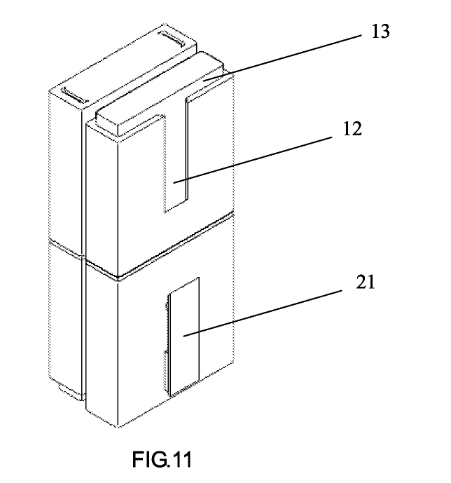

The fastener can be put into the groove through the hatch, and the connected markers are stable and easy to hold. FIG. 9 shows a schematic representation of the cap and the shank that are connected together of the marker according to the utility model. FIG. 10 shows a schematic representation of the connection procedure of two markers according to the utility model. When connecting two markers together, put the fastener 21 of one marker into the groove 12 of another marker, then two markers are connected. They are more convenient and ordered. FIG. 11 shows a schematic representation of two connected markers.

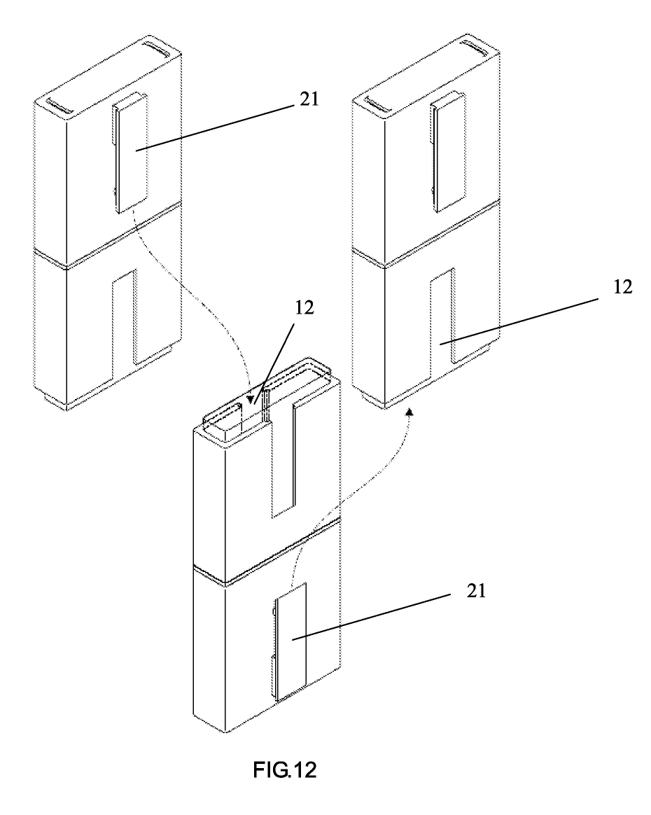

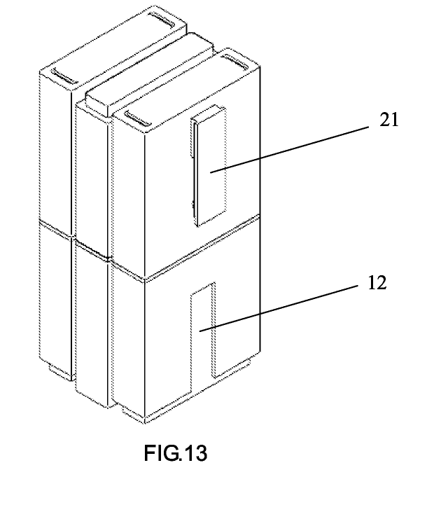

FIG. 12 shows a schematic representation of the connection procedure of three markers according to the utility model. First, the fastener 21 of one marker can be put into the groove 12 of the second one. Then, the fastener 21 of second one is put into the groove 12 of the third marker, then three markers are connected. FIG. 13 shows a schematic representation of three markers that are connected together. More markers can be connected together. Those connected markers look good; what's more, they are easy to arrange and hold. These markers can be arranged horizontally and vertically.

The above embodiments are used to help the person in the art understand and utilize the utility model. It's obvious that they can amend these embodiments according to general principle of the utility model without creative work. Therefore, the present utility model should not be defined by the above embodiments, and all the improvements and changes made by the skilled person in the art according to the utility model should be within the scope of protection.

What is claimed is:

1. A marker, wherein comprises a shank and a cap fitting over the shank, the front of the shank has a nib, the end of the shank has two grooves in its two sides and one side of the cap has a fastener.

2. A marker as claimed in claim 1, wherein the nib is 18 mm, 8 mm or fine line.

3. A marker as claimed in claim 1, wherein the shape of the fastener is quadrate.

4. A marker as claimed in claim 1, wherein the groove has a hatch at the bottom of the shank.

5. A marker as claimed in claim 1, wherein the shape of the groove is quadrate.

6. A marker as claimed in claim 1, wherein the fastener and the groove match with each other; the fastener and the groove are connected by putting the fastener of the cap into the groove of the shank through the hatch.

7. A marker as claimed in claim 1, wherein the shank and the cap are connected to form a cuboid.

8. A marker as claimed in claim 1, wherein the shank has a protrusion at the bottom of it.
